(19) United States
(12) Patent Application Publication
(10) Pub. No.: US 2007/0149003 A1
(43) Pub. Date: Jun. 28, 2007

(54) ELECTRONIC APPARATUS HAVING HIGH ELECTROMAGNETIC COMPATIBILITY

(75) Inventors: Arthur Chang, Taipei (TW); Fu-Ming Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 11/616,000

(22) Filed: Dec. 25, 2006

(30) Foreign Application Priority Data
Dec. 27, 2005 (CN) 200510132860.1

(51) Int. Cl. H01R 12/00

(52) U.S. Cl. 439/74

(57) ABSTRACT

A computer including a case, a first circuit board, a second circuit board, and a conductive unit is provided. The case has a first wall and a second conductive wall, and the first wall and the second wall are faced with each other. The first circuit board is fixed on the first wall and located between the first wall and the second wall. The second circuit board is located inside the case and has at least one electronic element located on the second circuit board. A first edge of the second circuit board is in contact with the first circuit board. The conductive unit is in contact with at least a part of the second circuit board and the second wall. The electronic elements in the computer have good electromagnetic compatibility.

### CROSS-REFERENCE TO RELATED APPLICATION

This application claims the priority benefit of P.R.C. application Ser. No. 200510132860.1, filed Dec. 27, 2005. All disclosure of the Chinese application is incorporated herein by reference.

### BACKGROUND OF THE INVENTION

1. Field of the Invention

The present invention relates to a computer, and more particularly, to a computer having high electromagnetic compatibility.

2. Description of the Related Art

Electromagnetic compatibility (EMC) is a key indicator to evaluate the quality of electronic apparatuses. The evaluation of EMC includes electromagnetic interference (EMI) and electromagnetic susceptibility (EMS). Since the advanced electronic apparatus transmits the signal in a higher speed, EMI caused by the electronic elements disposed in the electronic apparatus is more serious, which further impacts the normal operation of other electronic elements inside the electronic apparatus.

EMI has conductive and radical paths, and the radical EMI is usually resolved by modifying the circuit or the layout of the electronic elements. For example, in the display card of the computer, since a high frequency signal is generated on the display card, and the heat sink on the display card is operated in high temperature, thus a radical EMI is easily generated on other electronic elements in the computer.

### SUMMARY OF THE INVENTION

Therefore, it is an object of the present invention to provide a computer that comprises a plurality of internal components with high electromagnetic compatibility (EMC).

The present invention provides an computer including a case, a first circuit board, a second circuit board, and a conductive unit. The case has a first wall and a conductive second wall, and the first wall and the second wall are faced with each other. The first circuit board is fixed on the first wall and located between the first wall and the second wall. The second circuit board is located in the case and has at least one electronic element located on the second circuit board. A first edge of the second circuit board is in contact with the first circuit board. The conductive unit is in contact with at least a part of the second circuit board and the second wall.

In an embodiment of the present invention, the second circuit board further comprises a ground region, and the conductive unit is electrically connected to the ground region and the second wall.

In an embodiment of the present invention, the second circuit board further comprises a heat sink that is disposed on one side of the second circuit board, and the conductive unit is electrically connected to the heat sink and the second wall.

In an embodiment of the present invention, the second circuit board further comprises a ground region that is disposed neighboring to a second edge of the second circuit board, and the second edge is on an opposite side of the second edge.

In an embodiment of the present invention, the conductive unit is a conductive sheet having a first part and a second part, wherein the first part is fixed on the second wall, and the second part is in contact with at least a part of the second circuit board.

In an embodiment of the present invention, the conductive unit is a conductive sheet having a first part and a second part, wherein the first part is fixed on at least a part of the second wall, and the second part is in contact with the second circuit board.

In an embodiment of the present invention, the first edge of the second circuit board is plugged into a slot of the first circuit board.

In an embodiment of the present invention, the first circuit board is a motherboard, and the second circuit board is an function card.

In the preferred embodiment of the present invention, the heat sink of the second circuit board or a part of the second circuit board is grounded. Accordingly, the preferred embodiment of the present invention effectively suppresses the electromagnetic interference (EMI) on other electronic elements of the computer resulted from the second circuit board.

### BRIEF DESCRIPTION OF THE DRAWINGS

The accompanying drawings are included to provide a further understanding of the invention, and are incorporated in and constitute a portion of this specification. The drawings illustrate embodiments of the invention, and together with the description, serve to explain the principles of the invention.

FIG. 1 is a perspective view of a computer according to an embodiment of the present invention.

FIG. 2A is a top view of the computer in FIG. 1.

FIG. 2B is a cross sectional view taken along line I-I of FIG. 2A.

FIG. 3A is a top view of the computer in FIG. 1 with different configuration.

FIG. 3B is a cross sectional view taken along line II-II of FIG. 3A.

### DESCRIPTION OF PREFERRED EMBODIMENTS

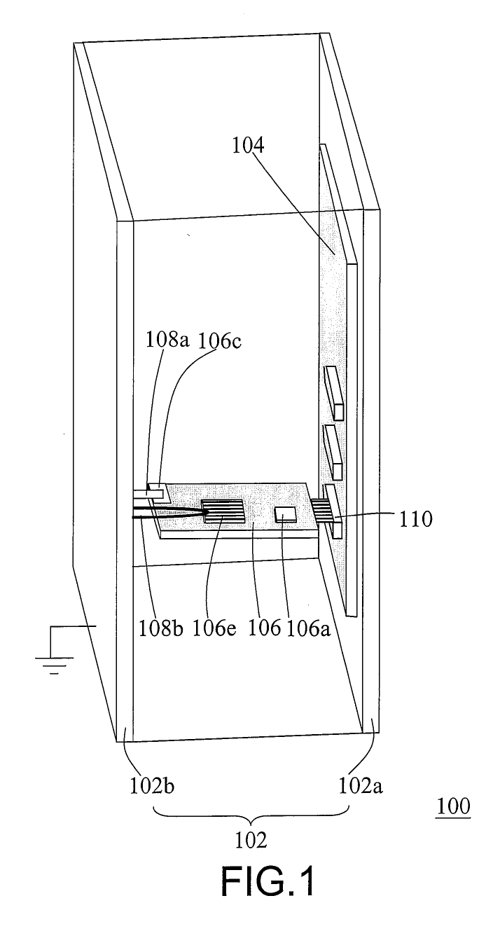

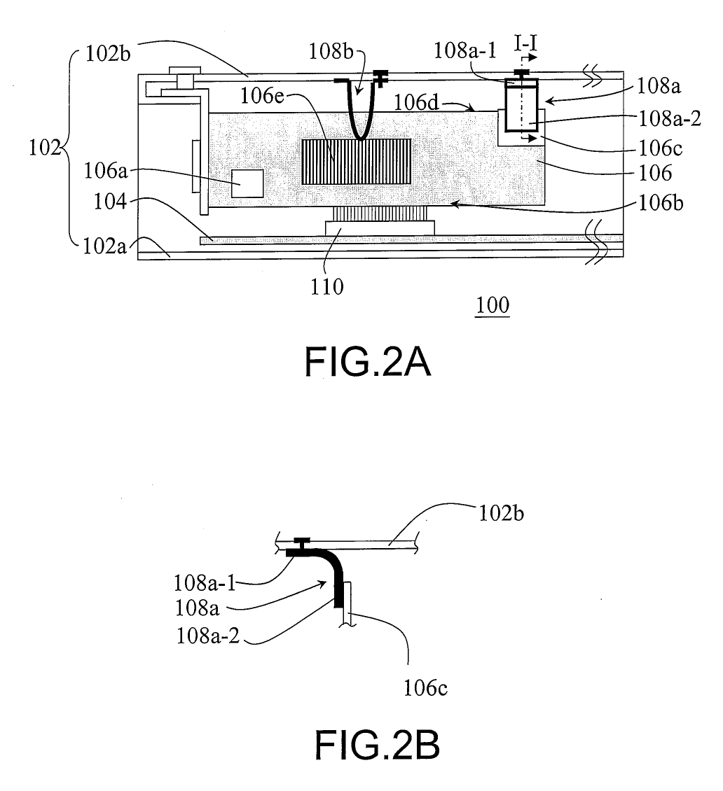

FIG. 1 is a perspective view of a computer according to an embodiment of the present invention. FIG. 2A is a top view of the computer in FIG. 1. FIG. 2B is a cross sectional view taken along line I-I of FIG. 2A.

Referring to FIG. 1, the computer 100 of the embodiment of the present invention includes a case 102, a first circuit board 104, a second circuit board 106, and two conductive units 108a and 108b, wherein the first circuit board 104 is a motherboard in the computer. In addition, the case 102 has a first wall 102a and a conductive second wall 102b, and the first wall 102a and the second wall 102b are faced with each other. The computer 100 is grounded through the conductive second wall 102b. The first circuit board 104 is fixed on the first wall 102a, and the first circuit board 104 is disposed between the first wall 102a and the second wall 102b.

Referring to FIG. 2A, the second circuit board 106 is disposed inside the case 102 and includes at least one electronic element 106a, such as a graphics processing unit (GPU). The electronic element 106a is disposed on the second circuit board 106. In this embodiment, the second circuit board 106 may be a display card. In other embodiments, the second circuit board 106 may be a function card which can be electrically connected to the first circuit board 104.

In addition, an edge 106b of the second circuit board 106 is in contact with the first circuit board 104 to transmit signal. Here, the edge 106b of the second circuit board 106 is plugged into a slot 110 of the first circuit board 104. However, the present invention is not limited by it; the second circuit board 106 may connect to the first circuit board 104 by other methods. In order to reduce the electromagnetic interference (EMI) on other electronic elements of the computer 100 from the second circuit board 106, a ground region 106c is further configured in the second circuit board 106. Accordingly, part of the charges accumulated on the second circuit board 106 is expelled from the second circuit board 106 through the ground region 106c.

Moreover, the ground region 106c should be configured on an area of the second circuit board 106 where the charges are easily accumulated. For example, the ground region 106c may be configured on an edge 106d that is disposed neighboring to the second circuit board 106. The edge 106d may be disposed on an opposite side of the edge 106b, or may be disposed on a side of the second circuit board 106 that is far from the edge 106b.

Furthermore, the second circuit board 106 may further include a heat sink 106e. Since the heat sink 106e easily generates EMI, the EMI problem can be effectively eliminated by grounding the heat sink 106e.

The method of grounding the second circuit board 106, especially the method of grounding through the ground region 106c and the heat sink 106e, is described in great detail hereinafter.

Referring to FIGS. 2A and 2B, the conductive unit 108a is in contact with at least a part of the second circuit board 106. Alternatively, the conductive unit 108a may be in contact with multiple parts of the second circuit board 106a based on different design requirements. The conductive unit 108b may be in contact with the ground region 106c of the second circuit board 106. The conductive unit 108b is electrically connected to the heat sink 106e and the second wall 102b, and the conductive unit 108a is electrically connected to the ground region 106c and the second wall 102b.

As shown in FIGS. 2A and 2B, the conductive unit 108a may be a conductive sheet having a first part 108a-1 and a second part 108a-2. The first part 108a-1 is fixed on the second wall 102b, and the second part 108a-2 is in contact with at least a part of the second circuit board 106, such as the ground region 106c. Since the second wall 102b is the ground terminal of the computer 100, the accumulated charges on each part of the second circuit board 106 are expelled to the outside.

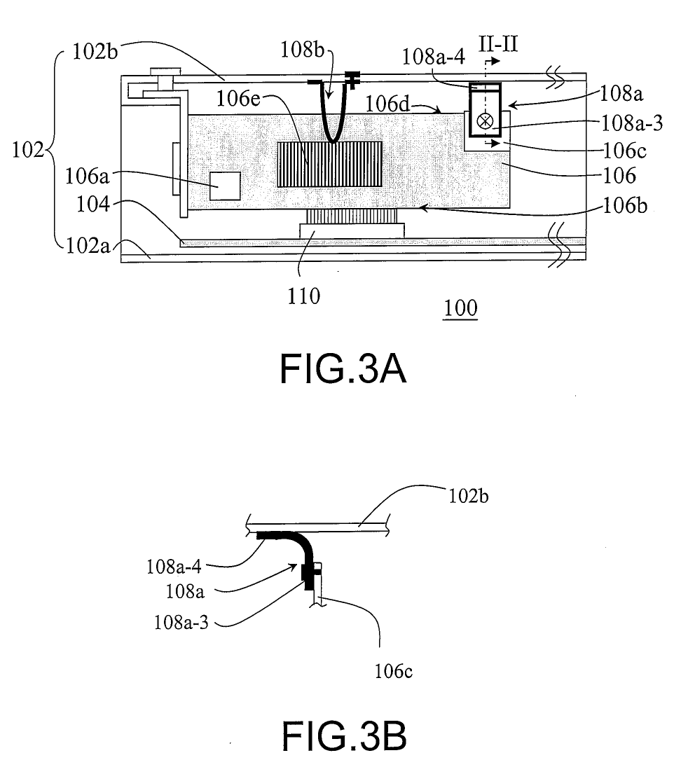

FIG. 3A is a top view of the computer in FIG. 1 with different configuration. FIG. 3B is a cross sectional view taken along line II-II of FIG. 3A.

Referring to FIGS. 3A and 3B, in another embodiment of the present invention, the conductive unit 108a is a conductive sheet with a different configuration. The conductive unit 108a has a first part 108a-3 and a second part 108a-4. The first part 108a-3 is fixed on at least apart of the second circuit board 106, such as the ground region 106c, and the second part 108a-4 is in contact with the second wall 102b. Similarly, the accumulated charges on each part of the second circuit board 106 are expelled to the outside.

In summary, the computer of the preferred embodiment of the present invention uses a conductive unit to electrically connect a second circuit board to the case, especially to electrically connect the heat sink of the second circuit board with the area where EMI is easily generated to the case, such that the accumulated charges on part of the second circuit board can be expelled through the grounding circuit of the case. Accordingly, the EMI caused by the second circuit board on other electronic elements in the computer is suppressed, and the internal electronic parts disposed in the computer have high electromagnetic compatibility.

Although the invention has been described with reference to a particular L embodiment thereof, it will be apparent to one of the ordinary skills in the art that modifications to the described embodiment may be made without departing from the spirit of the invention. Accordingly, the scope of the invention will be defined by the, attached claims not by the above detailed description.

What is claimed is:

1. A computer having high electromagnetic compatibility, comprising:
a case having a first wall and a second conductive wall, and the first wall and the second wall being faced with each other;
a first circuit board fixed on the first wall and located between the first wall and second wall;
a second circuit board disposed inside the case and having at least an electronic element that is disposed on the second circuit board, and a first edge of the second circuit board being in contact with the first circuit board; and
a conductive unit being in contact with at least a part of the second circuit board and the second wall.

2. The computer of claim 1, wherein the second circuit board further comprises a ground region, and the conductive unit electrically connects the ground region to the second wall.

3. The computer of claim 1, wherein the second circuit board further comprises a heat sink that is disposed on a side of the second circuit board, and the conductive unit electrically connects the heat sink to the second wall.

4. The computer of claim 1, wherein the second circuit board further comprises a ground region that is disposed neighboring to a second edge of the second circuit board, and the second edge is disposed on an opposite side of the first edge.

5. The computer of claim 1, wherein the conductive unit is a conductive sheet having a first part and a second part, the first part is fixed on the second wall, and the second part is in contact with at least a part of the second circuit board.

6. The computer of claim 1, wherein the conductive unit is a conductive sheet having a first part and a second part, the first part is fixed on at least a part of the second circuit board, and the second part is in contact with the second wall.

7. The computer of claim 1, wherein the first edge of the second circuit board is plugged into a slot of the first circuit board.

8. The computer of claim 1, wherein the first circuit board is a motherboard, and the second circuit board is a function card.
